(19) United States
(12) Patent Application Publication
(10) Pub. No.: US 2007/0196253 A1
(43) Pub. Date: Aug. 23, 2007

(54) Device for filling tubes, containers and the like with bulk materials

(76) Inventors: Karl-Heinz Stocksiefen, Troisdorf (DE); Hans-Josef Hundgen, Koln (DE); Wolfgang Rummel, Koln (DE)

Correspondence Address: CONNOLLY BOVE LODGE & HUTZ, LLP, P O BOX 2207, WILMINGTON, DE, 19899, US

(21) Appl. No.: 10/592,482

(22) PCT Filed: Mar. 14, 2005
(86) PCT No.: PCT/EP05/02682

§ 371 Date: Sep. 11, 2006

(30) Foreign Application Priority Data
Mar. 15, 2004 (DE) 102004012754.9

(51) Int. Cl. B01J 8/06

(52) U.S. Cl. 422/312

(57) ABSTRACT

The invention relates to an apparatus for introducing loose materials, in particular catalysts made up of small bodies, into tubes, containers and the like which has a number of charging units and a transport device (1) which moves all the charging units simultaneously. To achieve reliable and exact relocation of the filling units, the transport device comprises a baseplate (2) which can be moved back and forth, at least one piston-cylinder unit (3) fastened to the baseplate and one or more transport claws (5), with the transport claws being operatively connected to the piston-cylinder unit, being rotatable about a common axis and having their free end projecting through openings (6) in the baseplate into tubes (7), containers and the like and the length of the openings in the direction of movement of the baseplate being equal to or greater than the stroke of the piston-cylinder unit.

The invention relates to an apparatus for introducing loose materials into tubes, containers and the like which has a number of charging units and a transport device which can move the charging units simultaneously.

Shell-and-tube reactors are frequently used for carrying out chemical reactions in which gases are catalytically reacted. An example which may be mentioned is, in particular, the selective oxidation of hydrocarbons over fixed-bed catalysts. Since these reactions are exothermic, it is necessary to remove the heat of reaction as efficiently as possible from the reactor. If the reaction were to proceed in an uncontrolled fashion, there would be increased formation of undesirable by-products and expensive starting materials would be destroyed. A known way of removing the heat very efficiently is to fill tubes having very small diameters with catalysts and pass a coolant through the spaces between the tubes. Customary tube diameters for this purpose are from 2 to 5 cm, with a shell-and-tube reactor often having up to 40 000 individual tubes. From time to time, the catalyst has to be replaced in each individual tube.

Over the last decade, manual charging in which a measured amount of catalyst material was introduced via a funnel into each individual tube has been replaced by automatic charging. Manual charging is very time-consuming and therefore costly, and also the required uniformity of the rate of introduction and thus a uniform bed is not ensured.

To achieve an optimal yield and selectivity of the reactions carried out in the shell-and-tube reactor, it is important that all tubes of the reactor are filled very uniformly with the catalyst material. The same amount of catalyst material should be present in each tube and this material should be distributed very uniformly along the length of the tube. This reduces the risk of the reaction proceeding in an uncontrolled fashion.

Automatic charging of tubes with catalysts is known, for example, from U.S. Pat. No. 4,402,643. This document describes a frame which can travel on rollers and is provided with containers which taper in the direction of discharge of the granular material. From this, the loose material goes into a trough which can be vibrated by means of a vibrating unit and is divided into longitudinal chutes located next to one another. At the side of the trough are connection elements to which flexible hoses via which the loose material can be fed into the shell-and-tube reactors are fastened. However, the frame which travels on rollers is difficult to position exactly.

WO 98/14392, too, discloses a cart for charging reaction tubes. Compared to U.S. Pat. No. 4,402,643, this has improved electronically controlled vibrators which ensure precise control of the rate of introduction. However, the cart is very heavy and is difficult to position exactly via its bottom rollers.

Furthermore, DE-A 199 34 324 discloses a charging apparatus having slit-like movable elements which can be moved in two directions. These movable elements do allow very exact and simple positioning by manual means. This manual moving of the charging apparatus firstly requires manual dexterity on the part of the operating personnel and secondly requires some exertion, since such charging machines weigh about 40-65 kg. In addition, moving the apparatus manually is time-consuming.

It was therefore an object of the invention to provide a charging apparatus which allows many tubes to be loaded in parallel quickly, uniformly and simultaneously and also ensures reliable, exact and inexpensive relocation from one row of tubes to the next. An additional requirement was that the charging apparatus should be easy to install and allow a high working speed.

To achieve this object, the measures of claim 1 are proposed. The transport device which comprises a baseplate which can be moved back and forth, at least one piston-cylinder unit fastened to the baseplate and one or more transport claws, with the transport claws being operatively connected to the piston-cylinder unit, being able to be rotated about a common axis and having their free end projecting through openings in the baseplate into tubes, containers and the like, with the length of the openings in the direction of movement of the baseplate being equal to or greater than the stroke of the piston-cylinder unit, ensures reliable, rapid and uniform loading.

The baseplate used advantageously has at least the dimensions of from 10 to 20 rows of tubes. The baseplate is advantageously made of metallic material, preferably aluminum.

The piston-cylinder unit(s) is/are positively and frictionally connected to the baseplate and, when a plurality of units is used, are advantageously positioned parallel to one another. All piston-cylinder units known to those skilled in the art can be used. The piston-cylinder units are generally operated pneumatically or hydraulically, preferably pneumatically. The piston-cylinder units are matched to the dimensions of the rows of tubes, rows of containers or the like.

Advantageous embodiments of the apparatus of the invention are subject matter of the subordinate claims. When the apparatus is configured as indicated in claim 5, the charging units can be relocated in a particularly quick sequence. For this purpose, the stroke of the piston-cylinder unit is advantageously at least the sum of one tube diameter and one spacing between two tubes and not more than the sum of two tube diameters and one spacing between two tubes, preferably the sum of one tube diameter and one spacing between two tubes. In the case of shell-and-tube reactors, the individual tubes typically have a diameter of from 18 to 29 mm, in particular from 21 to 25 mm. The spacing between the individual rows of tubes is advantageously from 30 to 56 mm, in particular from 31 to 41.

In the case of a plurality of piston-cylinder units, these are preferably driven collectively. This control can advantageously be effected by means of a pneumatically operated button. Pressing the button thus allows the movement of the piston-cylinder units to be started. Releasing the button or pressing it again allows the movement of the piston-cylinder units to be reversed. The movement is advantageously triggered as a function of the fill level in the tube reactors or as a function of the amount of material in the charging apparatus.

The piston-cylinder units are connected by means of their push rods and a linkage to the transport claws. The linkage is preferably made of steel, in particular ST-37. The transport claws generally have an L-shape, with the free, shorter end advantageously projecting into the tubes. This shorter end is preferably a point or catch which has one straight edge and one oblique edge. The angle α between these two edges is advantageously from 40 to 60 degrees, in particular from 45 to 55 degrees. The length of the straight edge is advantageously from 30 to 50 mm. The length of the oblique edge is generally from 40 to 60 mm. The length of the longer end fixed to the linkages is usually from 120 to 140 mm. The transport claws typically have a width of from 3 to 5 mm. A suitable material for the transport claws is steel, in particular ST-37.

The length of the openings in the baseplate is advantageously greater than the stroke of the piston-cylinder unit. The width of the openings is matched to the dimensions of the transport claws.

The relocation of the charging apparatus advantageously occurs in two steps. In a first step, the piston-cylinder units are activated, for example after pressing of the pneumatic button, and the push rods of these units move in the direction of movement. As a result, the transport claws fastened to these push rods via the linkages likewise move in the direction of movement. Owing to their oblique edge, the claws slide over the rim of the tube into which they projected in the rest position and drop under their own weight into the next tube when the point of the free end of the claw has left the previous tube. The piston-cylinder units and the push rods are advantageously dimensioned so that the transport claws do not slide over a further tube. When the pneumatic button is pressed again or released, the movement of the piston-cylinder units is reversed. Due to the straight edge, the claws cannot leave the tube again on this side, but instead press against the tube wall. The force is then transmitted back via the linkage to the cylinder which is fixed to the baseplate and drives the baseplate to the end position of the push rods in the direction of movement. This displacement corresponds to the distance from one row of tubes to the next.

When a plurality of transport claws and cylinders are used, these move synchronously.

The charging apparatus generally comprises a plurality of charging units. Each charging unit comprises essentially a stock container, if appropriate a dispensing attachment, a feed chute, a discharge funnel and a charging tube. The charging apparatus advantageously comprises at least five parallel charging units, in particular at least 10 charging units, particularly preferably at least 20 charging units.

In the case of from 10 to 20 charging units, it is advantageous to use 2 or 3 piston-cylinder units and from 3 to 5 transport claws in the transport device.

A previously measured amount of loose material, e.g. catalyst, which is matched precisely to the reactor tubes can be discharged from the stock containers when required, or the required amount of loose material can be metered via a dispensing attachment which can be provided underneath the stock containers.

In the case of a charging apparatus having, for example, 20 charging units, it is advantageous to provide the charging apparatus with only half as many stock containers as there are charging units and to install dividing and storage units between the stock container and the feed chutes. This unit can accommodate the first portion of loose material while the second portion of loose material is introduced via the same stock container. The second portion of loose material is accommodated in a second separate storage unit, so that both portions of loose material can be fed simultaneously into the feed chutes. This preferred embodiment has the advantage that the stock containers can be of a practicable size without the spacing between the feed chutes or the feed chutes themselves becoming larger.

The portion of loose material which goes from the stock containers or from the storage unit onto the feed chutes is conveyed by means of vibration into the discharge funnels. A feed chute suitable for the purpose generally has a length of from 45 to 65 mm. The feed chutes advantageously have a U-shape. The vibrations are advantageously generated pneumatically. The feed chutes are advantageously inclined by from 5 to 20° to the surface of the tube reactor. Discharge funnels are provided at the end of the feed chutes. Charging tubes are fastened to the discharge funnels.

The discharge funnel generally has a diameter in the same order of magnitude as the reactor tubes. As a result, the charging rate at the outlet of the charging tubes is already matched to the charging rate of the tubes of the shell-and-tube reactor, so that continuous charging with avoidance of bridges of loose material during charging can occur.

The charging apparatus can be employed for charging one or more vertical reactor tubes with any free-flowing loose material. The charging apparatus is particularly useful for charging reactor tubes with catalysts for preparing, in particular, phthalic anhydride, maleic anhydride and acrylic acid. The catalyst material is usually in the form of small spheres, disks, cylinders, rings or pellets. The catalysts preferably have a dish shape with a diameter of a few mm, in particular a diameter of from 5 to 10 mm.

Automatic relocation is advantageous, since, firstly, the equipment takes over the exact positioning and rapid, reliable positioning can therefore be effected, and secondly, the relocation process and thus the total charging time can be accelerated considerably. It may be pointed out that in the case of 40 000 tubes, the charging apparatus has to be relocated about 2000 times.

In addition, the weight of the charging apparatus is no longer a limiting factor when relocation occurs automatically. Thus, a larger number of parallel charging units can be accommodated in a charging apparatus. This means large cost and time savings.

Furthermore, a pneumatically operated transport device has a safety advantage, since no electric voltage is applied in the closed reactor, and the pneumatically operated transport device ensures independence from the available electric power supply.

The invention is illustrated below with reference to the drawings.

In the drawings:

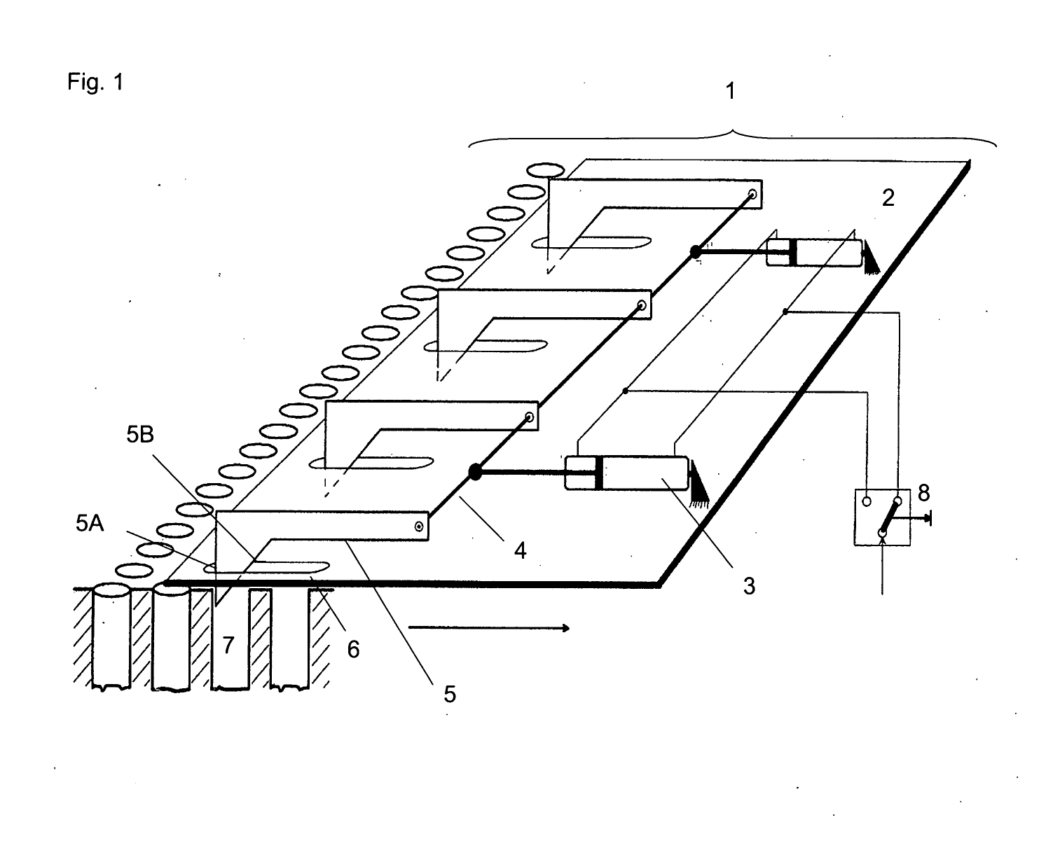

FIG. 1 shows a perspective view of a transport device

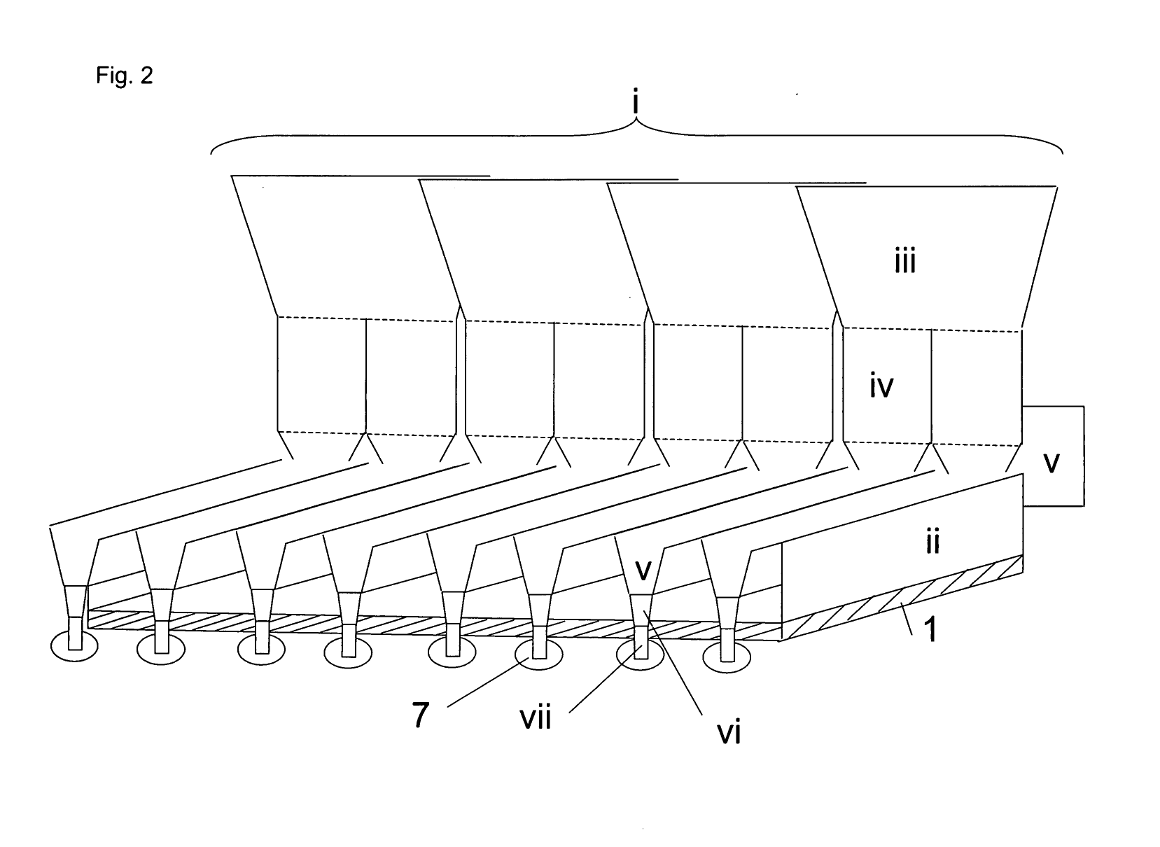

FIG. 2 shows a side view of a plurality of charging units.

The transport device 1 comprises essentially a baseplate 2 onto which two piston-cylinder units 3 are fastened. The push rods of the piston-cylinder units are connected via the linkage 4 to transport claws 5. The free ends of the transport claws project through openings 6 in the baseplate into the tubes 7 of the shell-and-tube reactor. The transport claws 5 have one straight edge 5A and one oblique edge 5B. The relocation of the transport device is triggered with the aid of a pneumatic button 8. When the button is pressed, the claws 5 are drawn back from their rest position by means of the push rods of the piston-cylinder units 3. Due to the oblique edge 5B, this movement of the transport claws is not stopped at the rim of the tube; the transport claws slide over the rim of the tube and the free claws drop into the tube of the next row. When the button 8 is pressed again, the movement of the cylinder 3 is reversed. However, owing to the straight edge 5A, the claws 5 can no longer leave the tube on this side, but instead press against the wall. The force is then transmitted back via the linkage 4 to the cylinders 3 which are fixed to the baseplate 2 and drives the baseplate 2 to the end position of the push rods. This displacement corresponds to the distance from one row of tubes to the other. The transport device is consequently back in the initial position and the procedure can be repeated.

A plurality of charging units are fastened to the transport device according to the invention. The charging units i are located on a support ii to which further components are fastened. Dividing and storage units iv are provided below the stock containers iii containing the loose material. In the storage units, the loose material for two reaction tubes is stored separately during sequential charging of the stock containers, so that the loose material reaches the feed chute v simultaneously. One feed chute is provided for each reaction tube. Below the feed chutes, there is a vibrating unit vi which vibrates the feed chutes so that the loose material is conveyed from the outlet of the storage unit iv to the discharge funnel vii. From the feed chute, which ends in a discharge funnel vii, the loose material, which may be made up of small bodies, dust or granules, goes into the charging tubes viii. The charging tubes are located directly above the reactor tubes 7 to be charged.

1-10. (canceled)

11. A transport device for introducing loose materials into tubes, containers and the like, wherein the transport device comprises a baseplate which can be moved back and forth, at least one piston-cylinder unit fastened to the baseplate and one or more transport claws, with the transport claws being operatively connected to the piston-cylinder unit, being rotatable about a common axis and having their free end projecting through openings in the baseplate into tubes, containers and the like and the length of the openings in the direction of movement of the baseplate being equal to or greater than the stroke of the piston-cylinder unit.

12. The apparatus according to claim 11, wherein the piston-cylinder unit is operated pneumatically or hydraulically.

13. The apparatus according to claim 11, wherein the piston-cylinder unit is operated pneumatically.

14. The apparatus according to claim 11, wherein the free end of the transport claws has a straight edge opposite to the direction of movement of the baseplate and an oblique edge in the direction of movement of the baseplate.

15. The apparatus according to claim 11, wherein the stroke of the piston-cylinder unit corresponds to at least the sum of one tube diameter and one spacing between two tubes and not more than the sum of two tube diameters and one spacing between two tubes.

16. The apparatus according to claim 11, wherein the transport device has from two to three piston-cylinder units and from three to five transport claws.

17. The apparatus according to claim 11, wherein the piston-cylinder units can be driven collectively.

18. An apparatus for introducing loose materials into tubes, containers and the like which has a number of charging units comprising a transport device according to claim 11, which moves all the charging units simultaneously.

19. The apparatus according to claim 18, wherein from 10 to 20 charging units are arranged in parallel.

20. The apparatus according to claim 19, wherein at least approximately parallel feed chutes which are operatively connected to one or more vibrating unit(s) are provided underneath the stock containers for the loose material.

21. The apparatus according to claim 18, wherein the charging units have feed chutes which have a U-shape and are inclined at from 5 to 20° to the surface of the tube reactor.

22. The apparatus according to claim 18, wherein outflow funnels which have a diameter in the same order of magnitude as the reactor tubes are located at the end of the feed chutes.

23. The use of the apparatus according to claim 18 for introducing catalysts into shell-and-tube reactors.
